(19) United States
(12) Patent Application Publication
(10) Pub. No.: US 2014/0207586 A1
(43) Pub. Date: Jul. 24, 2014

(54) Displaying Method for Third-Party Information

(71) Applicant: RICHPLAY INFORMATION CO., LTD., New Taipei City (TW)

(72) Inventors: Hai-Tao WO, Shanghai City (CN); Yi-Hsiang CHEN, New Taipei City (TW)

(73) Assignee: RICHPLAY INFORMATION CO., LTD., New Taipei City (TW)

(21) Appl. No.: 13/890,737

(22) Filed: May 9, 2013

(30) Foreign Application Priority Data
Jan. 21, 2013 (TW) 102102184

(51) Int. Cl. G06Q 30/02

(52) U.S. Cl. CPC G06Q 30/0277
USPC 705/14.73

(57) ABSTRACT

A displaying method for third-party information allows a first server to transmit at least one piece of third-party information to a first device according to at least one preference model, at least one piece of page information, a piece of location information, or a piece of time information. The third-party information can be also randomly transmitted to the first device. Thereby, the third-party information and a webpage accessed by the first device are concurrently displayed on the first device. The transmission of the third-party information from the first server needs no authorization from the website owner. Moreover, the third-party information can cover or overlap the webpage to be concurrently displayed on the first device so that the third-party information is not limited by the typesetting of the webpage. Accordingly, a simpler and more flexible displaying method for the third-party information is provided.

### 1. FIELD OF THE INVENTION

The present invention relates to a displaying method for third-party information, particularly to a displaying method that the third-party information transmitted by a server and a webpage surfed by users can be displayed concurrently.

### 2. DESCRIPTION OF THE RELATED ART

While computers and Internet are developing, people spend more time on the Internet, and people also rely on the Internet to get daily information gradually. Herein, when the Internet is getting popular, information on the Internet can be published with a better advertising effect. Thus, more enterprises may utilize the Internet to advertise and increase the publicity of their commodities besides traditionally promoting their products on newspaper, magazines, or other print media like the exterior appearances of buildings or transportation. Moreover, the on-line shopping is also popular recently, and consumers gradually get used to shopping on the Internet. Therefore, electronic advertisement on the Internet can preferably increase the publicity of the commodity. When the advertisement is clicked, consumers are guided to the webpage that promotes the commodity. Namely, the obstruction of shopping behavior gets decreased because it becomes easier to persuade consumers to shop in a short time. Thereby, the need for advertising on the Internet increases every year.

Wherein, two issues should be concerned while the electronic advertisement is to be published on the Internet: the location or the style of the advertisement, and the cost for publishing the advertisement. Speaking to the location or the style of the advertisement, the general electronic advertisement published on the webpage is usually arranged on a previously fixed location like the side banner or the transverse banner close to the top of the webpage. The publicity of the electronic advertisement on the webpage decreases while the location of the advertisement gets lower on the webpage. There is another kind of dynamic electronic advertisement that covers the whole webpage and presents while it auto runs after the webpage is loaded. However, in time of presenting the auto-run advertisement, the loading of the webpage is just completed. Thus, if consumers are concurrently using other software or other Internet services, it is hard for them to notice the auto-run advertisement. In the past, the charge for the electronic advertisement can be decided according to the surfing times of the webpage. Herein, the surfing times merely reflect that the consumers passively receive the electronic advertisement; the surfing times do not count the consumers' active wishes, so the surfing times can not reflect how the consumer is interested in the advertisement. Thus, the surfing times of the advertisement are difficult to be linked to the actual advertising effect. Today, the charge of the electronic advertisement on the Internet is mostly decided according to the clicking times of the advertisement. Moreover, the clicking times can be also considered as a basis for evaluating the advertising effect. However, there are so much information and electronic advertisement on the Internet, so most users have fewer desires to surf or to click the advertisement. As a result, the advertising effect of the advertisement or the effort in counting consumers' wishes is decreased or in vain. Further, the cost for publishing the electronic advertisement on the popular websites is not low. Also, limitations in the advertising styles, the presenting ways, and the broadcasting time are all unilaterally regulated by the website owner.

Although consumers are not interested in most of the electronic advertisement, the opportunity that the consumers surf or click the electronic advertisement might be enhanced while the topic of the commodity is interesting to them or when the commodity is just what they need. Thus, the advertising effect of the electronic advertisement might be enhanced by properly collecting consumers' personal information or their behavior models. Namely, while the personal information or the behavior models are properly collected and analyzed, the electronic advertisement can be released directly to those who are interested in and who actually need the commodity. However, according to a research made by an on-line investigating organization Krux Digital, there are at least 86% users saying that they switch on the function of “Do-not-track” while they are surfing the Net. Thus, users' personal information is prohibited from being collected randomly for customizing any advertisement correspondingly. Therefore, some enterprises keep trying to persuade consumers to open their on-line activities for tracking by providing consumers with some free services.

In order to conquer the unsatisfactory presenting ways of the electronic advertisement on the webpage and the unideal charging means of the same, the present invention provides a displaying method for third-party information. The method of the present invention provides third-party information suited to display the electronic advertisement or other non-advertisement to end users. In the method of the present invention, a server transmits the third-party information to a user's device, so that the third-party information and the webpage can be concurrently displayed on user's device. In time of displaying, the displaying area or the displaying location of the third-party information will not be restricted by the webpage, so that the presenting ways of the advertisement can be more various. Moreover, the displaying of the third-party information does not have to rely on the website owner, so the third-party information will not be restricted or charged. Whereby, the cost of publishing or the broadcasting the third-party information can be decreased.

There are at least four displaying method for the third-party information disclosed in the present invention: First, the third-party information can be transmitted according to the preference of users; Second, the third-party information related to the topic of the webpage that users are surfing can be transmitted accordingly; Third, the third-party information is sifted according to user's location and time zone, so that the third-party information can be transmitted to the end user according to his region and time zone; Fourth, one piece of the third-party information is randomly selected from some preset third-party information. Herein, the first displaying method has to previously collect the behavior information generated while users are surfing the Net. Thence, the behavior information is analyzed for establishing a preference model, and the third-party information that most meets users' preference can be sifted according to the preference model. The second displaying method has to access the page information that users are surfing. Thence, the third-party information that is related to the content of the webpage can be sifted according to the relationship (such as keywords or videos) to the page information. The third displaying method requires users' Internet protocol (IP) for analyzing users' locations or time zones. The fourth displaying method requires no users' information; it randomly selects from the present third-party information.

Except the first displaying method, other displaying methods do not ask users for too much personal information. Moreover, the method of the present invention can cooperate with other existing functions. For example, a program can be designed to collect users' preference models, concurrently display the third-party information according to users' preference, and also provide an individual webpage that users are able to instantly discuss with each other at the same time. Accordingly, users may be willing to agree their behavior information to be collected in order to leave messages or discuss with other users on the webpage.

The present invention also allows the original provider of the third-party information, namely, the third party, to set the time zone, the region, the website type (of a single website), the user's type (according to the behavior information, the preference model, and other personal information), and the presenting means of the third-party information. Namely, how the third-party information is displayed can be customized according to the needs of the third party.

### SUMMARY OF THE INVENTION

The object of the present invention is to provide a displaying method for third-party information that allows the third-party information that is sifted according to a user's preference model to be transmitted while the user is surfing the Net. Preferably, the third-party information and the webpage are concurrently displayed, and the third-party information that is preferred by the user can be displayed properly. Favorably, the presenting means of the third-party information will not be restricted by the typesetting of the webpage or the website owner.

A further object of the present invention is to provide a displaying method for third-party information. The third-party information sifted according to the page information can be transmitted while the user is surfing the Net. Preferably, the third-party information and the webpage are concurrently displayed showing that the third-party information is related to the topic of the webpage that the user is surfing. Favorably, the presenting means of the third-party information will not be restricted by the typesetting of the webpage or the website owner.

A further object of the present invention is to provide a displaying method for third-party information. The third-party information can be transmitted according to the region or the time zone of the user while the user is surfing the Net. Preferably, the third-party information and the webpage are concurrently displayed, and the third-party information is displayed according to the region or the time zone of the user. Favorably, the presenting means of the third-party information will not be restricted by the typesetting of the webpage or the website owner.

A further object of the present invention is to provide a displaying method for third-party information. The preset third-party information can be transmitted while the user is surfing the Net. Moreover, the third-party information and the webpage are concurrently displayed. Accordingly, when the third-party information lacks user's preference model or the page information related to the third-party information, the third-party information can be still displayed to the user. Favorably, the presenting means of the third-party information will not be restricted by the typesetting of the webpage or the website owner.

One of the objects of the present invention can be achieved by the present invention providing a displaying method for third-party information. Steps of the method comprise: a first server sifting at least one piece of third-party information according to a preference model and transmitting the third-party information to a first device; and the third-party information and a webpage accessed by the first device being concurrently displayed on the first device. Wherein, the preference model is established by analyzing at least one piece of behavior information of the first device. The preference model can be also established on the first device and thence transmitted to the first server via the first device. The preference model can be also established on the first server and related to at least one piece of nearby information of the first device.

Another one of the objects of the present invention can be achieved by the present invention providing a displaying method for third-party information. Steps of the method comprise: a first server sifting at least one piece of third-party information according to at least one piece of page information included in a webpage and transmitting the third-party information to a first device; and the third-party information and the webpage being concurrently displayed on the first device. Wherein, the page information includes a website of the webpage, at least one paragraph of the webpage, at least one picture of the webpage, at least one video of the webpage, at least one piece of embedded exterior information of the webpage, or at least one externally-connected website of the webpage.

Another one of the objects of the present invention can be achieved by the present invention providing a displaying method for third-party information. Steps of the method comprise: a first server accessing a piece of location information or a piece of time information of a first device according to an Internet protocol of the first device; at least one piece of third-party information being sifted according to the location information or the time information and transmitted to the first device; and the third-party information and a webpage accessed by the first device being concurrently displayed on the first device.

Another one of the objects of the present invention can be achieved by the present invention providing a displaying method for third-party information. Steps of the method comprise: a first server randomly selecting at least one piece of third-party information from at least one piece of third-party information and transmitting the third-party information to the first device; and the third-party information and a webpage accessed by the first device being concurrently displayed on the first device.

### BRIEF DESCRIPTION OF THE DRAWINGS

FIG. 1A is a schematic view of a first preferred embodiment of the present invention showing the correlation of the elements;

FIG. 1B is a flowchart of the first preferred embodiment of the present invention;

FIG. 2A is a schematic view of a second preferred embodiment of the present invention showing the correlation of the elements;

FIG. 2B is a flowchart of the second preferred embodiment of the present invention;

FIG. 3A is a schematic view of a third preferred embodiment of the present invention showing the correlation of the elements;

FIG. 3B is a flowchart of the third preferred embodiment of the present invention;

FIG. 4A is a schematic view of a fourth preferred embodiment of the present invention showing the correlation of the elements; and

FIG. 4B is a flowchart of the fourth preferred embodiment of the present invention.

### DETAILED DESCRIPTION OF THE PREFERRED EMBODIMENTS

The advantages of the present invention over the known prior art will become more apparent to those of ordinary skilled in the art upon reading the following descriptions in junction with the accompanying drawings.

A displaying method for third-party information is characterized in that: the third-party information is transmitted while users are surfing the Net, so that the third-party information and the webpage can be concurrently displayed. Thereby, the displaying of the third-party will not be restricted by the typesetting of the webpage and regulated by the website owner, which increases flexibility of presentation. The present invention is able to sift the third-party information according to a preference model established by a piece of behavior information of the user, or according to a piece of page information of a webpage that the user is surfing. The present invention is also able to transmit the third-party information according to the region and the time zone of the user, or able to transmit the third-party information randomly. Thereby, the presented third-party information preferably meets the preference of the user or is interested to the user, which increases the chance that the user surfs or clicks on the third-party information. Accordingly, the advertising effect of the third-party information is enhanced. Alternatively, the third-party information can be transmitted to several users that are in the same region or the same time zone. A sifting standard of the third-party information can be decided and set by an original provider, namely a third party, so as to customize a piece of proper third-party information for presentation since it more complies with the need of the user.

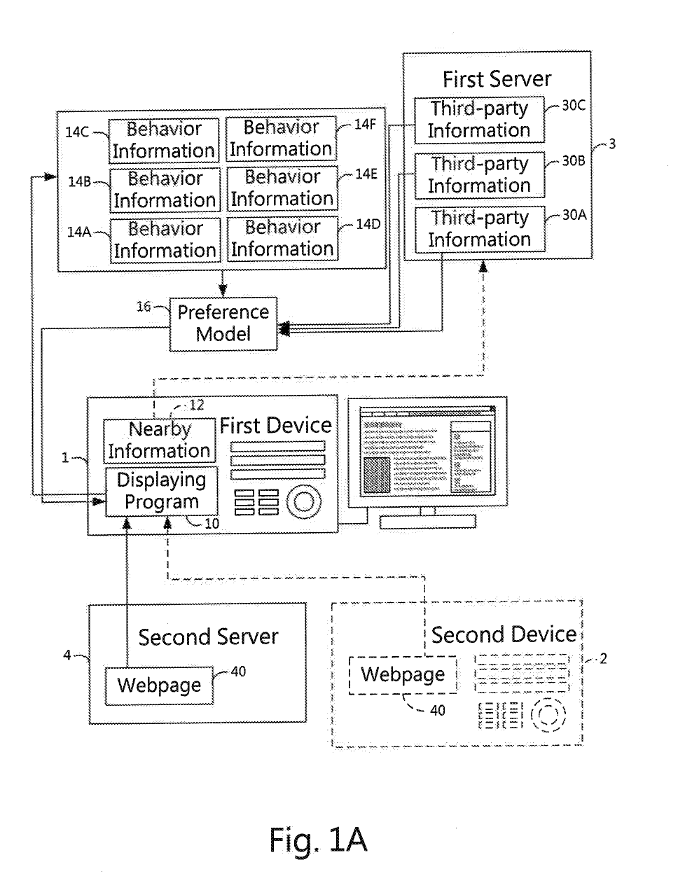

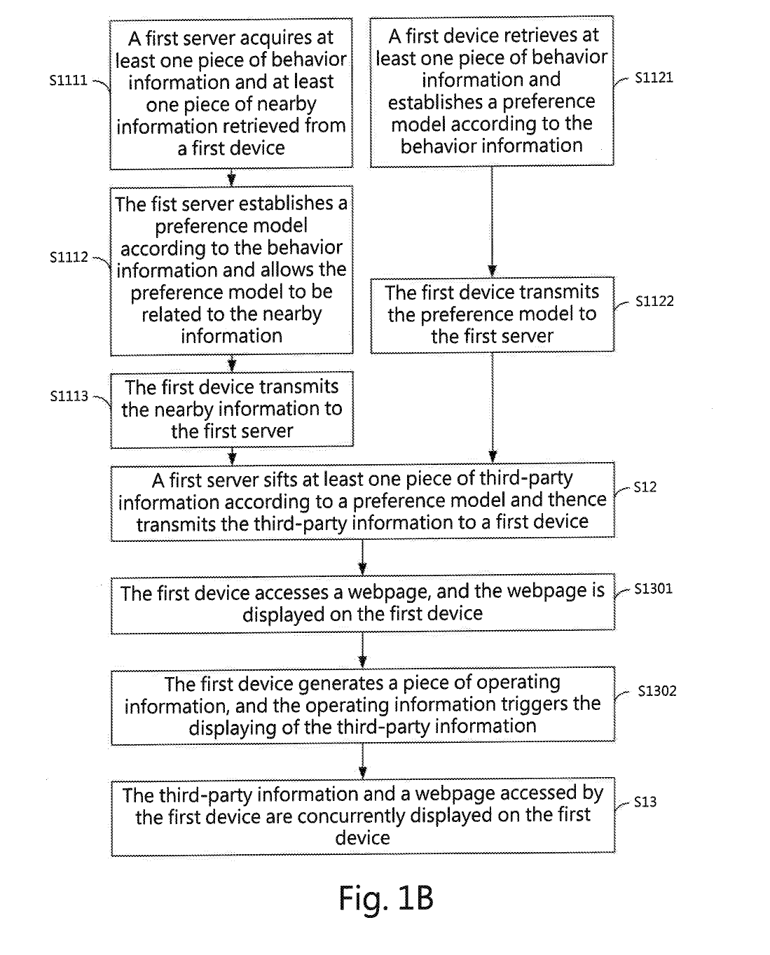

Referring to FIGS. 1A and 1B, a schematic view of a first preferred embodiment of the present invention shows the correlation of the element and a flowchart of the same. Referring to FIG. 1A, a displaying method for third-party information comprises a first device 1 and a first server 3. The first server 3 includes at least one piece of third-party information 30A˜30C. The first device 1 is connected to the first server 3. The first server 3 transmits one of the third-party information 30A according to a preference model. 16 to the first device 1, so that the third-party information 30A that meets the preference of the user can be presented to the user at the first device 1.

Wherein, the preference model 16 can be established by analyzing several pieces of behavior information 14A˜14F. These pieces of behavior information 14A˜14F are retrieved from the first device 1. Namely, these pieces of behavior information 14A˜14F are accessed from the first server 3 and analyzed to establish the preference model 16. Therefore, the preference model 16 can be related to at least one piece of nearby information 10 of the first device 1. Alternatively, these pieces of behavior information 14A˜14F can be analyzed by the first device 1 so as to establish the preference model 16. Thereby, the preference model 16 can exist in the first server 3 or in the first device 1.

The present invention further comprises a second device 2 or a second server 4. The second device 2 or the second server 4 includes a webpage 40. The first device 1 is connected to the second device 2 or the second server 4, so that the webpage 40 can be accessed from the second device 2 or the second server 4. If the first device 1 or the first server 3 includes the webpage 40, then the first device 1 can also access the webpage 40 from the first device 1 or the first server 3. Namely, the user at the first device 1 is able to surf the webpage freely at a local end, a nearby Net, or a far Net. Besides the first device 1 being connected to the first server 3 and the second server 4 as shown in FIG. 1A, the first device 1 can be firstly connected to the first device 3 and thence connected to the second server 4 via the first server 3. Moreover, in this embodiment, the first server 1 further includes a displaying program 10 that can be a particular or an existing Internet Explorer (such as IE, Firefox, Chrome, safari, or Opera). The displaying program 10 can further cooperate with an explorer plugin that receives and displays the third-party information or provide functions that concurrently display the webpage and the third-party information to the user. The displaying program 10 further includes a function that is able to retrieve the nearby information 12 and the pieces of behavior information 14A˜14F or establish the preference model 16.

The first server 3 in this embodiment sifts the third-party information 30A from several pieces of third-party information 30A˜30C via the preference model 16. Herein, the sifted third-party information 30A is the one that most attracts the user at the first device 1. Namely, the third-party information is customized and displayed to the user, which may enhance the chance that the user clicks on the third-party information so as to augments the displaying effect of the third-party information.

Referring to FIG. 1B, the displaying method for third-party information includes steps of:

Step S12: a first server sifts at least one piece of third-party information according to a preference model and thence transmits the third-party information to a first device; and

Step S13: the third-party information and a webpage accessed by the first device are concurrently displayed on the first device.

In order to establish and use the preference model 16 so as to sift those pieces of third-party information 30A˜30C, some steps are launched before the step S12 as follows:

Step S1111: a first server acquires at least one piece of behavior information and at least one piece of nearby information retrieved from a first device;

Step S1112: the first server establishes a preference model according to the behavior information and allows the preference model to be related to the nearby information;

Step S1113: the first device transmits the nearby information to the first server;

Step S1121: a first device retrieves at least one piece of behavior information and establishes a preference model according to the behavior information; and

Step S1122: the first device transmits the preference model to the first server.

According to the steps S111˜S1113, the preference model 16 is established in the first server 3 and related to the nearby information 12. According to the steps S1121˜S1122, the preference model 16 is established in the first device 1.

In the step S1111, the first device 1 is connected to the first server 3. The displaying program 10 retrieves the nearby information 12 and transmits the nearby information 12 to the first server 3. The nearby information 12 includes a piece of software serial number information of the displaying program 10, a piece of hardware code information of the first device 1, or a piece of website information connected of Internet connected to the first device 1. If the displaying program 10 logins in and connects to the first server 3 through an account, the nearby information 12 thence includes a piece of account information. The first server 3 differentiates the user at the first device 1 through the nearby information 12. Thence, when the user at the first device 1 surfs the Net or uses other Internet services, the displaying program 10 continually collects the pieces of behavior information 14A˜14F generated in the first device 1. For example, at least one piece of exploring history or at least one downloading record of the behavior information 14A˜14F will be transmitted to the first server 3. In the step S1112, the first server 3 analyzes those pieces of behavior information 14A˜14F so as to establish the preference model 16 accordingly. The first server 3 also allows the preference model. 16 to be related to the nearby information 12. Thus, in the step S1113, the first device 1 is connected to the first server 3 again. The displaying program 10 retrieves the nearby information 12 and transmits the nearby information 12 to the first server 3. Thence, the first server 3 is able to acquire the preference model 16 established in the steps S1111 to S1112 from the related nearby information 12. Accordingly, the third-party information 30A can be sifted from those pieces of third-party information 30A˜30C via the preference model 16 in the subsequent step S12.

Further, in the step S1121, the displaying program 10 still collects the pieces of behavior information 14A˜14F from the webpage that the user at the first device 1 is surfing or in time of the user using other Internet services. Those pieces of behavior information 14A˜14F are analyzed for establishing the preference model 16. In the step S1122, the first device 1 is connected to the first server 3. After the first server 3 receives the preference model 16 transmitted from the first device 1, the pieces of third-party information 30A˜30C can be sifted via the preference model 16 in the subsequent step S12.

In the step S12, the first server 3 acquires the preference model 16 established in the steps S1111 to S1113 or in the steps S1121 to S1122. The pieces of third-party information 30A˜30C are sifted via the preference model 16. One piece of the third-party information 30A more complies with the preference of the user at the first device 1. The first device 1 receives the third-party information 30A through the displaying program 10. In the step S13, the first device 1 accesses the webpage 30 from the second server 4 through the displaying program. The displaying program 30 thence allows the third party information 30A and the webpage 40 to be concurrently displayed on the first device 1. Namely, the third-party information 30A more meets the preference of the user who is at the first device 1 and surfing the webpage 40.

Further, the following steps can be launched after the step S12 and before the step S13:

Step S1301: the first device accesses a webpage, and the webpage is displayed on the first device; and

Step S1302: the first device generates a piece of operating information, and the operating information triggers the displaying of the third-party information.

In the step S1301, the first device 1 accesses the webpage 40 included in the second server 4 through the displaying program 10. The displaying program 10 allows the webpage 40 to be displayed on the first device 1. In the step 1301, the user who is at the first device 1 and surfing the webpage 40 allows a piece of operating information (not shown) to be generated. The operating information includes a piece of searching information that is generated when the user executes a searching command, a piece of clicking information that is generated when the user clicks on any links in the webpage 40, a piece of directing information that is generated when the user moves the cursor to a certain piece of page information in the webpage 40 (such as a paragraph, a picture, a video, or a piece of embedded exterior information), or a piece of scrolling information that is generated when the user scrolls the webpage 40. Wherein, the operating information triggers the displaying program 10 to display the third-party information 30A, so that the third-party information 30A and the webpage 40 are concurrently displayed on the first device 1. When the user at the first device 1 surfs the webpage 40, he sees the third-party information 30A at the same time. As previously described, the user at the first device 1 is able to connect with any devices or servers so as to surf any webpages at the local end, at the nearby website, or at the far website. The source of the webpage neither influences the third-party information 30A transmitted from the first server 3 nor stops the displaying program 10 from concurrently displaying the third-party information 30A and the webpage 40 on the first device to the user. Namely, the displaying of the third-party information is not restricted by the user at the second device or the website owner of the second server. Preferably, the displaying of the third-party information needs no authorization, so that correlated costs can be reduced. Favorably, the time for discussing with the website owner about the displaying manner of the third-party information is also saved. Namely, the third party just has to discuss with the owner of the first server 3 about the displaying manner of the third-party information, and then the third-party information can be displayed to the user at the first device 1 while the user is surfing the webpage.

The manner that the third-party information 30 and the webpage 40 being concurrently displayed on the first device 1 allows the third-party information 30 to totally or partially cover the webpage 40. Namely, the third party information 30 is able to spread over the window of the Internet explorer, or it can be arranged on a fixed location or an unfixed location of the window of the Internet explorer so as to cover a part of the webpage 40. Wherein, the webpage 40 may include at least one piece of page information such as at least one paragraph, at least one picture, at least one video, or at least one piece of embedded exterior information. The third-party information 30 is set to cover aforementioned page information for being displayed. Herein, since the user mainly focuses on the page information when he is surfing the webpage, the third-party information 30 can more attract the user's attention when the third-party information 30 covers the page information. Moreover, the displaying of the third-party information can be triggered by the operating information generated while the user is surfing the webpage. Wherein, when the user executes some operations, such as moving the cursor to the particular page information or clicking on the link included in the page information in the webpage 40, the third-party information covers the page information that the user is focusing on. Therefore, the third-party information attracts the user's attention. Further, the third-party information 30 is set translucent. Accordingly, when the third-party information 30 is displayed, the content of the webpage 40 can be still recognized through the third-party information 30, which decreases the interference to the user in time of displaying the third-party information 30. Accordingly, the user may not feel that annoyed at the displayed third-party information 30.

By means of the method of the present invention, the third-party information is customized for meeting user's preference. Moreover, the displaying manner is not restricted by the typesetting or regulated by the website owner. Besides, the method of the present invention also allows the third-party information to be related to the webpage that the user is surfing, so that the third-party information can be properly displayed as shown in the second preferred embodiment.

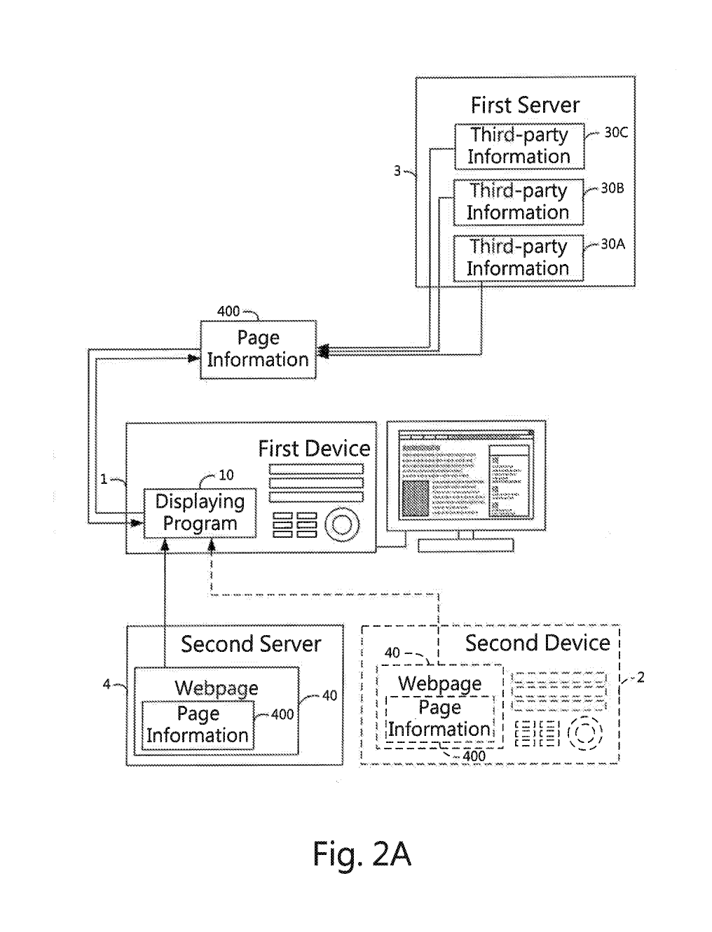

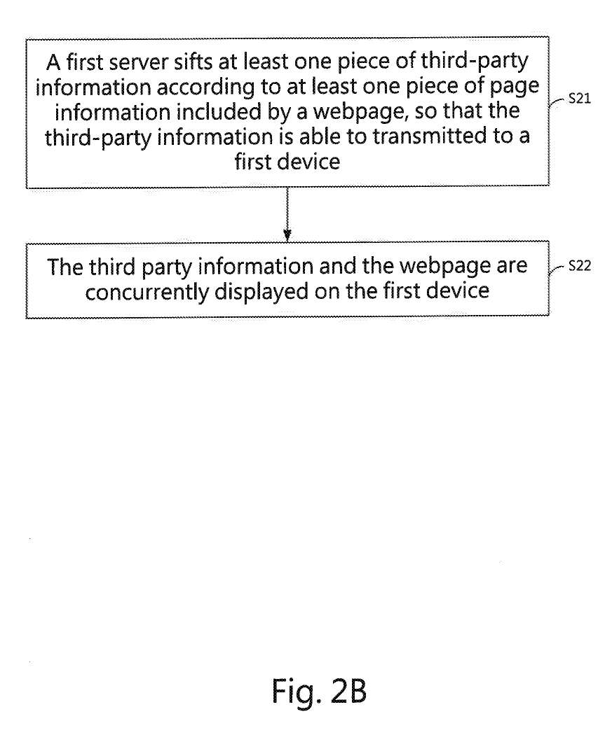

Referring to FIGS. 2A and 2B, a schematic view and a flowchart show a second preferred embodiment of the present invention. Referring to FIG. 2A, the displaying method for third-party information comprises a first device 1 and a first server 3. The first server 3 includes at least one piece of third-party information 30A˜30C. The first device 1 is connected to the first server 3. The first server 3 transmits one of the third-party information 30B according to a piece of page information 400 included by a webpage 40 to the first device 1, so that the third-party information 30B that is related to the webpage 40 that the user is surfing can be presented to the user at the first device 1. Wherein, the webpage 40 may include at least one piece of page information such as at least one website, at least one paragraph, at least one picture, at least one video, or at least one piece of embedded exterior information. Moreover, at least one web type that is tagged or defined on the webpage 40 can be found according to the website, or at least one web type of the webpage 40 can be judged by the first device 1 or the first server 3 according to the paragraph, the picture, the video, or the embedded exterior information. Thence, the page information 400 is retrieved from the webpage 40 in the first device 1 and transmitted to the first server 3, or the page information 400 can be retrieved from the webpage 40 in the first server 3.

Similar to the first preferred embodiment, the present invention further comprises a second device 2 or a second server 4. The second device 2 or the second server 4 includes a webpage 40 that has at least one piece of aforementioned page information 400. The first device 1 is connected to the second device 2 or the second server 4, so that the webpage 40 can be accessed via the second device 2 or the second server 4. If the first device 1 or the first server 3 includes the webpage 40, the first device 1 accesses the webpage 40 via the first device 1 or the first server 3. Namely, the user at the first device 1 is able to surf the webpage freely via a local end, a nearby a nearby Net, or a far Net. Besides the first device 1 can be connected to the first server 1 and the second server 4, the first device 1 can be also firstly connected to the first server 1 and thence connected to the second server 4 via the first server 1. In this embodiment, the first server 1 further includes a displaying program 10 that can be a particular or an existing Internet Explorer for further cooperating with an explorer plugin that receives and displays the third-party information or provide functions that concurrently display the webpage and the third-party information to the user. The displaying program 10 further includes a function that is able to retrieve the page information 400.

This embodiment is characterized in that the first server 3 sifts the third-party information 30B related to the page information 400 from the pieces of third-party information 30A˜30C through the page information 400. Herein, the third-party information 30B is related to the webpage 40 that the user at the first device 1 is surfing, so the third-party information 30B is able to attract the attention of the user at the first device 1. Accordingly, the user at the first device 1 may be willing to watch and click on the third-party information, so that the displaying effect of the third-party information is enhanced.

Referring to FIG. 2B, the displaying method for third-party information of the present invention includes steps as follows:

Step S21: a first server sifts at least one piece of third-party information according to at least one piece of page information included by a webpage, so that the third-party information is able to transmitted to a first device; and

Step S22: the third party information and the webpage are concurrently displayed on the first device.

In the step S21, the first device 1 is connected to the first server 3 and the second server 4, thereby the second server 4 being able to access the webpage 40. The displaying program 10 retrieves the page information 400 and transmits the page information 400 to the first server 3. Additionally, if the first device 1 is connected to the first server 3 and thence connected to the second server 4 through the first server 4, the page information 400 can be directly retrieved from the webpage 40 in the first server 3. The first server 3 sifts the third-party information 30B related to the page information 400 from the pieces of third-party information 30A˜30C. Herein, the first server 3 utilizes keywords, pictures, videos, or other embedded plugins. Namely, the third-party information 30B that is related to the page information 400 can be defined by looking for the keywords or the pictures, analyzing the videos or file features, or intellectually judging the type of the webpage (according to the keywords or the relationship to the files). Thence, the third-party information 30B is transmitted to the first device 1. In the step S22, the displaying program 10 allows the webpage 40 accessed by the second server 4 and the third-party information received by the first server 3 to be concurrently displayed on the first device 1. Therefore, when the user is surfing the webpage 40 at the first device 1, he is able to see the third-party information 30B that is related to the webpage 40.

In this embodiment, after the step S21 and before the step S22, a piece of operating information is generated for triggering the third-party information to be displayed. Similar steps like the steps S1301 to S1302 in the first preferred embodiment are hereby omitted. The user is able to click on or move the cursor to a piece of page information, In this embodiment, the page information that the user is looking at is reflected for being analyzed so as to provide the user with the third-party information that is most related to the topic of the webpage that the user is surfing. Thus, the third-party information can be more accepted by the user.

In fact, this preferred embodiment of the present invention allows the user to be provided with the third-party information that is related to the topic of the webpage. Moreover, the displaying manner will not be restricted by the typesetting of the webpage and regulated by the website owner. Further, the third-party information that is related to the region or the time zone of the user can be also provided in the third preferred embodiment.

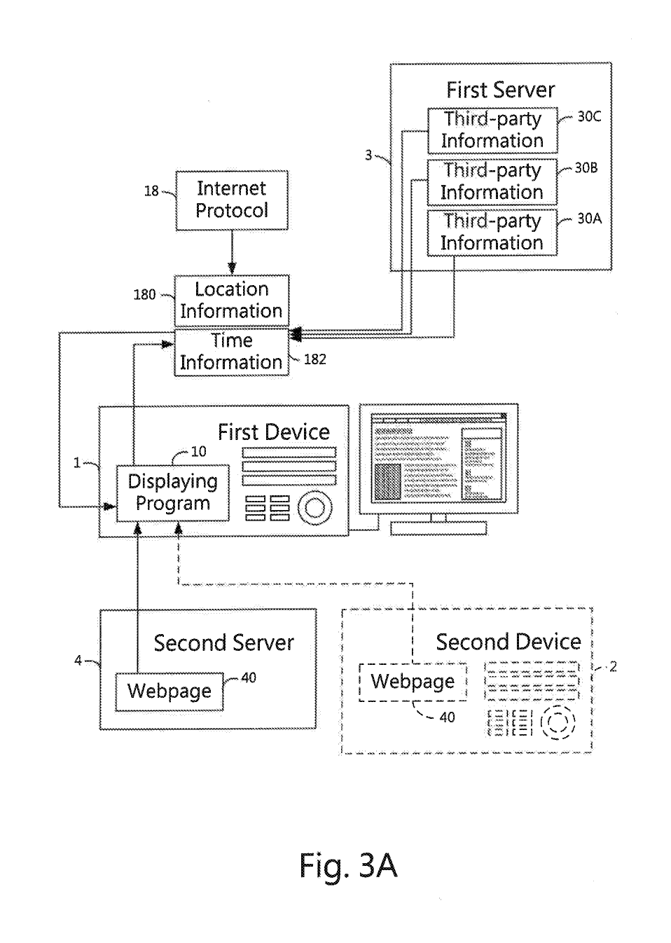

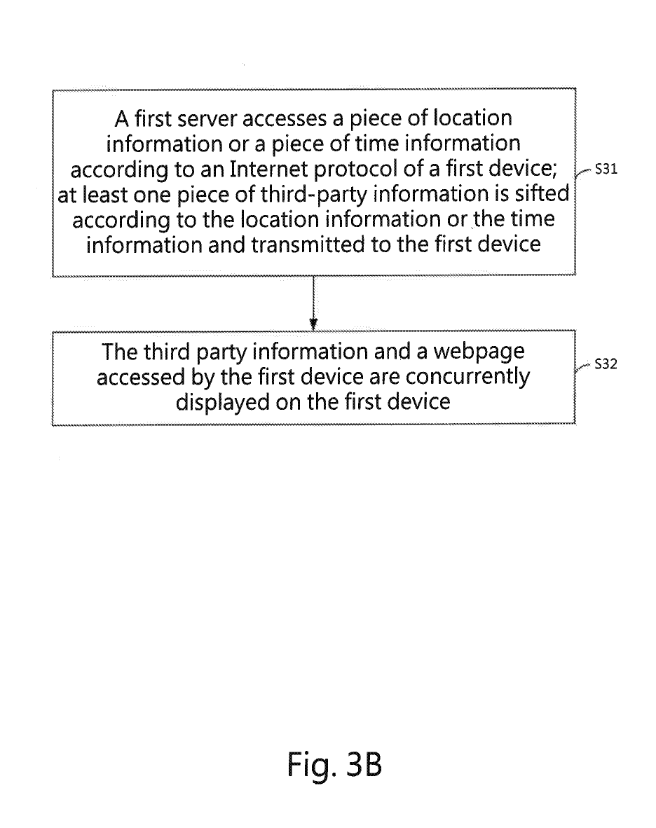

Referring to FIGS. 3A and 3B, a schematic view and a flowchart show a third preferred embodiment of the present invention. Referring to FIG. 3A, the displaying method for third-party information comprises a first device 1 and a first server 3. The first server 3 includes at least one piece of third-party information 30A˜30C. The first device 1 is connected to the first server 3. The first server 3 transmits one piece of third-party information 30C to the first device 1 according to a piece of location information 180 or a piece of time information 182 from an Internet protocol 18 of the first device 1. Therefore, the third-party information 30C can be displayed to the user at a certain region or in a certain time zone. Wherein, the Internet protocol 18 can be transmitted from the first device 1 to the first server 3 or actively retrieved from the first server 3.

Similar to the first preferred embodiment, the method of the present invention in this preferred embodiment further includes a second device 2 or a second server 4. The second device 2 or the second server 4 includes a webpage 40. The first device 1 is connected to the second device 2 or the second server 4, so that the webpage 40 can be accessed via the second device 2 or the second server 4. If the first device 1 or the first server 3 includes the webpage 40, the first device 1 is able to access the webpage 40 from the first device 1 or the first server 3. Namely, the user at the first device 1 is able to surf the webpage freely at a local end, a nearby Net, or a far Net. Further, besides the manner that the first device 1 is connected to the first server 3 and the second server 4 as shown in FIG. 3A, the first device 1 can be firstly connected to the first server 3 and thence connected to the second server 4 through the first server 3. Further, in this embodiment, the first server 1 further includes a displaying program 10 that can be a particular or an existing Internet Explorer. The displaying program 10 can further cooperate with an explorer plugin that receives and displays the third-party information or provide functions that concurrently display the webpage and the third-party information to the user. Moreover, the displaying program 10 includes the function for retrieving the Internet protocol 18.

The feature of this preferred embodiment is that the first server 3 accesses the region or the time zone of the first device via the Internet protocol 18. The third-party information 30C is selected from the third-party information 30A˜30C according to the location information and the time information. Thereby, the third-party information 30C can be displayed to the user using the first device 1 at the same region and the same time zone. Namely, the third-party information is displayed to a particular group of people.

Referring to 3B, the displaying method for third-party information of the present invention includes the following steps:

Step S31: a first server accesses a piece of location information or a piece of time information according to an Internet protocol of a first device; at least one piece of third-party information is sifted according to the location information or the time information and transmitted to the first device; and

Step S32: the third party information and a webpage accessed by the first device are concurrently displayed on the first device.

In the step S31, the first device 1 is connected to the first server 3, and the displaying program 10 transmits the Internet protocol 18 to the first server 3. Wherein, the first server 3 acquires a piece of location information 180 or a piece of time information 182 of the first device 1 through the Internet protocol 18. Thence, the third-party information 30C is selected according to the location information 180 or the time information 182 and thence transmitted to the first device 1. The first device 1 receives the third-party information 30C through the displaying program 10. In the step S32, the first device 1 accesses the webpage 40 from the second server 4 through the displaying program 10. The displaying program 10 allows the third-party information 30C and the webpage 40 to be concurrently displayed on the first device 1. Accordingly, the third-party information 30C can be displayed to the user who is surfing the webpage 40 at the first device 1 and who is in the particular region or time zone. Further, after the step S31 and before the step S32, a piece of operating information is further generated for triggering the third-party information to be displayed. Herein, the steps similar to the steps S1301 to S1302 are omitted.

By means of aforementioned embodiment, the present invention allows the user at a certain region or at a certain time zone to be provided with the third-party information. Moreover, the displaying manner is not restricted by the typesetting of the webpage or regulated by the website owner.

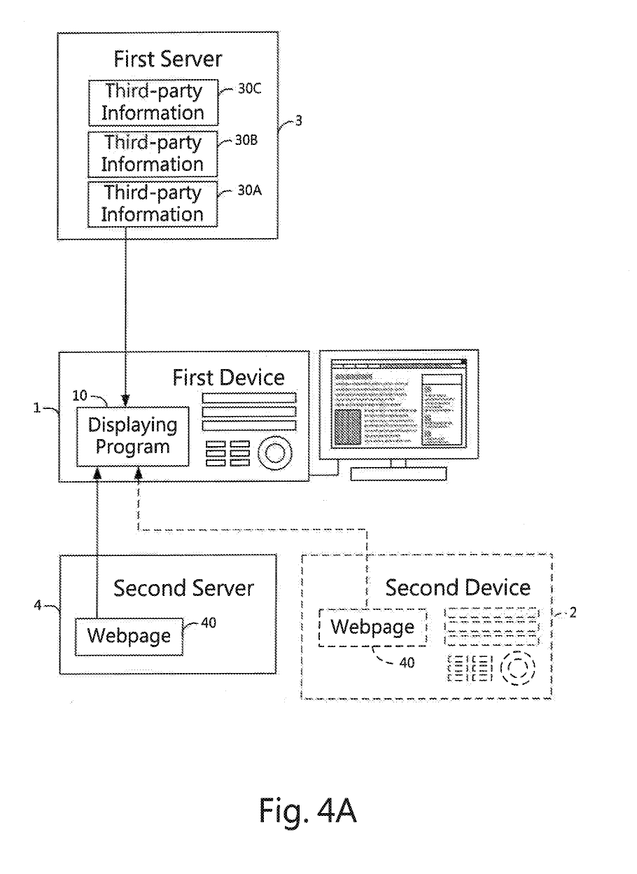

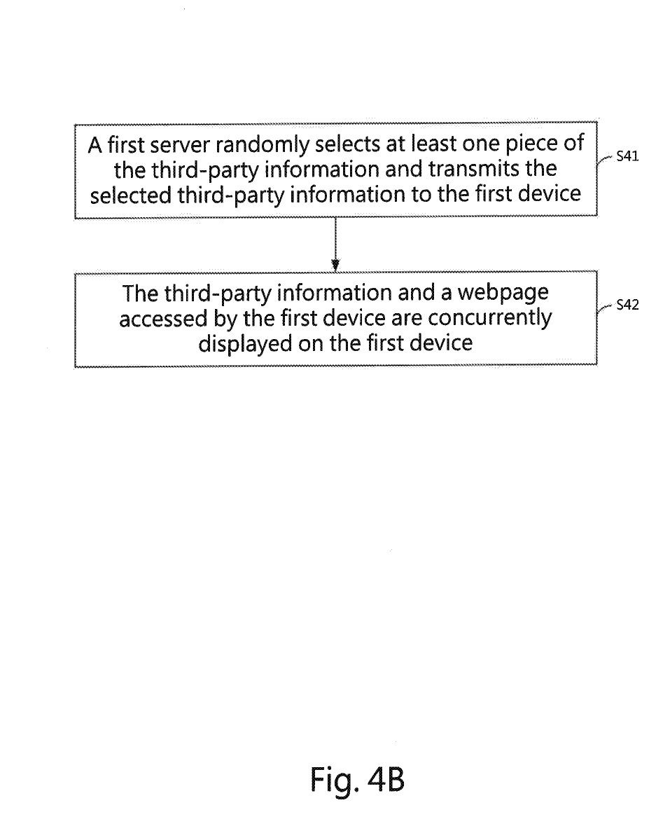

Referring to FIGS. 4A and 4B, a schematic view and a flowchart show a fourth preferred embodiment of the present invention. Referring to FIG. 4A, the displaying method for third-party information comprises a first device 1 and a first server 3. The first server 3 includes at least one piece of third-party information 30A˜30C. The first device 1 is connected to the first server 3. The first server 3 randomly transmits one piece of third-party information 30A to the first device 1. Thereby, one of the third-party information 30A˜30C can be displayed to the user at the first device 1.

Similar to the first preferred embodiment, the method of the present invention in this preferred embodiment further comprises a second device 2 or a second server 4. The second device 2 or the second server 4 includes a webpage 40. The first device 1 is connected to the second device 2 or the second server 4, so that the webpage 40 can be accessed via the second device 2 or the second server 4. Moreover, if the first device 1 or the first server 3 includes the webpage 40, the first device 1 is able to access the webpage 40 through the first device 1 or the first server 3. Namely, the user at the first device 1 is able to surf the webpage freely at a local end, a nearby Net, or a far Net. Besides the first device 1 being connected to the first server 3 and the second server 4 as shown in FIG. 4A, the first device 1 can be firstly connected to the first device 3 and thence connected to the second server 4 via the first server 3. Moreover, the first server 1 further includes a displaying program 10 that can be a particular or an existing Internet Explorer. The displaying program 10 can further cooperate with an explorer plugin that receives and displays the third-party information or provide functions that concurrently display the webpage and the third-party information to the user.

The feature of this embodiment is that the first server 3 is able to randomly transmit one of the third-party information 30A˜30C to the first device 1. Wherein, the method in this embodiment neither has to collect or retrieve the personal information or the behavior information of the user nor analyzes the webpage that the user is surfing. The method in this embodiment can be employed in the situation that there is no third-party information meeting user's preference, the topic in the webpage that the user is surfing, or the region or the time zone of the user.

Referring to FIG. 4B, the displaying method for the third-party information comprises the following steps:

Step S41: a first server randomly selects at least one piece of the third-party information and transmits the selected third-party information to the first device; and

Step S42: the third-party information and a webpage accessed by the first device are concurrently displayed on the first device.

In the step S41, the first device 1 is connected to the first server 3. The first server 3 thence randomly selects one piece of third-party information 30A from the third-party information 30A˜30C. Thereby, the selected third-party information 30A is transmitted to the first device 1, and the first device 1 receives the third-party information 30A through the displaying program 10. In the step S42, the first device 1 accesses the webpage 40 from the second server 4 through the displaying program 10. The displaying program 10 allows the third-party information 30A and the webpage 40 to be concurrently displayed on the first device 1. Thereby, one of the third-party information 30A˜30C can be randomly displayed to the user who is surfing the webpage 40 at the first device 1. Moreover, after the step S41 and before the step S42, a piece of operating information is similarly generated for triggering the third-party information to be displayed. These steps similar to the steps S1301 to S1302 in the first preferred embodiment are herein omitted.

To sum up, the displaying method for third-party information of the present invention is neither restricted by the typesetting of the webpage nor regulated by the website owner. Therefore, the method of the present invention is freer and more convenient. When the third-party information is provided according to the user's preference, the webpage that the user is surfing, the time zone and the region of the user, or a random means, the displaying effect of the third-party information can be increased. Or while the third-party information is displayed to particular users, the third-party information can more meet the need of the users.

I claim:

1. A displaying method for third-party information comprising:
a step of using a first server for sifting at least one piece of third-party information according to a preference model and transmitting said third-party information to a first device; and
a step of allowing a webpage accessed by said third-party information and said first device to be concurrently displayed on said first device.

2. The method as claimed in claim 1, wherein, steps for establishing said preference model include:
a first server accessing at least one piece of behavior information and at least one piece of nearby information retrieved from a first device; and
said first server establishing a preference model according to said behavior information and allowing said preference model to be related to said nearby information.

3. The method as claimed in claim 2, wherein, said nearby information includes a piece of account information, a piece of software serial number information, a piece of hardware code information, or a piece of website information.

4. The method as claimed in claim 2, wherein, using said first server for sifting said third-party information further include:
a step of using said first device for transmitting said nearby information to said first server; and
a step of using said first server for sifting said third-party information according to said preference model related to said nearby information.

5. The method as claimed in claim 2, wherein, a way for establishing said preference model includes a step of:
using said first device for retrieving at least one piece of said behavior information and establishing said preference model according to said behavior information.

6. The method as claimed in claim 5, wherein, using said first server for sifting said third-party information according to said preference model further include:
a step of using said first device for transmitting said preference model to said first server; and
a step of using said first server for sifting said third-party information according to said preference model.

7. The method as claimed in claim 1, after said step of using said first server for transmitting said third-party information to said first device and before said step of allowing said third-party information and said webpage to be concurrently displayed on said first device further includes:
a step of using said first device for accessing a webpage, and said webpage being displayed on said first device; and
a step of generating a piece of operating information in said first device for triggering said third-party information to display.

8. The method as claimed in claim 1, wherein, said third-party information covers said webpage completely, partially or translucently.

9. A displaying method for third-party information comprising:
a step of using a first server for sifting at least one piece of third-party information according to at least one piece of page information included by a webpage and transmitting said third-party information to a first device; and
a step of allowing said third-party information and said webpage to be concurrently displayed on said first device.

10. The method as claimed in claim 9, wherein, said page information includes a website of said webpage, at least one paragraph of said webpage, at least one picture of said webpage, at least one video of said webpage, at least one piece of embedded exterior information of said webpage, or at least one externally-connected website of said webpage.

11. The method as claimed in claim 9, after said step of using said first server for transmitting said third-party information to said first device and before said step of allowing said third-party information and said webpage to be concurrently displayed on said first device further includes:
a step of using said first device for accessing a webpage, and said webpage being displayed on said first device; and
a step of generating a piece of operating information in said first device for triggering said third-party information to display.

12. The method as claimed in claim 9, wherein, said third-party information covers said webpage completely, partially or translucently.

13. The method as claimed in claim 9, wherein, said third-party information covers said page information completely, partially or translucently.

14. A displaying method for third-party information comprising:
a step of using a first server for accessing a piece of location information or apiece of time information of a first device according to an Internet protocol of said first device, and said first server sifting at least one piece of third-party information according to said location information or said time information and transmitting said third-party information to said first device; and
a step of allowing said third-party information and a webpage accessed by said first device to be concurrently displayed on said first device.

15. The method as claimed in claim 14, after said step of using said first server for transmitting said third-party information to said first device and before said step of allowing said third-party information and said webpage to be concurrently displayed on said first device further includes:
a step of using said first device for accessing a webpage, and said webpage being displayed on said first device; and
a step of generating a piece of operating information in said first device for triggering said third-party information to display.

16. The method as claimed in claim 14, wherein, said third-party information covers said webpage completely, partially or translucently.

17. A displaying method for third-party information comprising:
a step of using a first server for randomly selecting at least one piece of third-party information from at least one piece of third-party information and transmitting said third-party information to a first device; and
a step of allowing said third-party information and a webpage accessed by said first device to be concurrently displayed on said first device.

18. The method as claimed in claim 17, after said step of using said first server for transmitting said third-party information to said first device and before said step of allowing said third-party information and said webpage to be concurrently displayed on said first device further includes:
a step of using said first device for accessing a webpage, and said webpage being displayed on said first device; and
a step of generating a piece of operating information in said first device for triggering said third-party information to display.

19. The method as claimed in claim 17, wherein, said third-party information covers said webpage completely, partially or translucently.
